(19) United States
(12) Patent Application Publication
(10) Pub. No.: US 2013/0048628 A1
(43) Pub. Date: Feb. 28, 2013

(54) Baking Helper Device, and Method of Using Thereof

(71) Applicant: VERED MENASHE-FRIEDMAN, Kfar-Yona (IL)

(72) Inventor: VERED MENASHE-FRIEDMAN, Kfar-Yona (IL)

(21) Appl. No.: 13/592,476

(22) Filed: Aug. 23, 2012

Related U.S. Application Data
(60) Provisional application No. 61/573,069, filed on Aug. 25, 2011.

(51) Int. Cl. H05B 6/80; F28F 7/00

(52) U.S. Cl. 219/730; 165/80.1

(57) ABSTRACT

A device for hastening a rise of dough placed inside a bowl, the device comprising: an internal member made of fabric, the internal member comprising a plurality of interconnected chambers having therein solid dry grains that are heatable in a microwave oven or in other suitable way; and an external member or sleeve, to enclose therein said internal member after said internal member is heated in the microwave oven, wherein the device is wrapable around said bowl.

### PRIOR APPLICATION DATA

This application claims priority and benefit from U.S. Provisional Patent Application 61/573,069, filed on Aug. 25, 2011, which is hereby incorporated by reference in its entirety.

### FIELD OF THE INVENTION

The present invention relates to the field of baking and preparation of baked goods.

### BACKGROUND

Baking is a method of food cooking which typically utilizes prolonged dry heat. For example, baked potatoes or baked apples may be prepared by placing a fresh potato or fresh apple, respectively, in a hot oven for a preset time period (e.g., thirty minutes).

Baked goods may include, for example, various types of bread, cakes, pastries, pies, cookies, or the like. Baking may be performed in an electric oven, an open-fire oven (e.g., for preparing pizza), or other suitable baking device.

Some baked goods are prepared from dough, which may be a paste of cereals, grains or crops that are ground into flour and mixed with water or other suitable liquid.

### SUMMARY

The present invention may include, for example, a device which may resemble a small, thin, generally-rectangular pillow having multiple pockets or chambers. The chambers may store one or more types of dry grains, for example, buckwheat or kasha. The device may be warmed- up or heated, for example, in a microwave oven or in an oven. The heated device may retain warmth or heat, and may be wrapped around or tied around a bowl. The bowl may include dough or other ingredients intended for baking or cooking The heated pillow-shaped device may wrap around the bowl, and may cause the dough or other ingredients to raise or rise faster or in a rapid manner, thereby reducing the time period required for preparation of certain baked goods or cooked goods.

Optionally, the device may be environmentally-friendly (“green”), such that substantially all the components of the device may be natural, non-artificial, recyclable, and/or bio-degradable. The device may motivate home users to bake food items at home, thereby allowing home users to enjoy home-baked goods which may be healthier and/or less expensive and/or more nutritious relative to purchased food items.

The present invention may include a device for hastening a rise of dough placed inside a bowl, the device comprising: an internal member made of fabric, the internal member comprising a plurality of interconnected chambers having therein solid dry grains that are heatable in a microwave oven; and an external member to enclose therein said internal member after said internal member is heated in the microwave oven, wherein the device is wrapable around said bowl.

In accordance with some demonstrative embodiments of the present invention, the external member comprises two or more cords to tie together two opposite sides of the device when the device is wrapped around said bowl.

In accordance with some demonstrative embodiments of the present invention, the external member comprises a fabric pocket; a first side of the pocket is closed; and a second, opposite, side of the pocket is open.

In accordance with some demonstrative embodiments of the present invention, the second side of the pocket comprises a closing and opening mechanism.

In accordance with some demonstrative embodiments of the present invention, the closing and opening mechanism comprises a zipper.

In accordance with some demonstrative embodiments of the present invention, the closing and opening mechanism comprises a fabric hook-and-loop fastener.

In accordance with some demonstrative embodiments of the present invention, the internal member is generally rectangular, the external member is generally rectangular, and each chamber is generally rectangular.

In accordance with some demonstrative embodiments of the present invention, a long dimension of the internal member is generally perpendicular to a long dimension of said chambers.

In accordance with some demonstrative embodiments of the present invention, the solid dry grains comprise one or more grains selected from the group consisting of: buckwheat, kasha, flax, linen, rye.

In accordance with some demonstrative embodiments of the present invention, the filling further comprises an aromatic agent.

In accordance with some demonstrative embodiments of the present invention, the aromatic agent comprises one or more materials selected from the group consisting of: dry lavender, laurel leaves, daphne leaves, Bay leaves, flowers, dried flowers, aromatic extracts, one or more spices, aroma-emitting components, and aroma-therapeutic agents.

In accordance with some demonstrative embodiments of the present invention, the filling further comprises a moisture-absorbing ingredient.

In accordance with some demonstrative embodiments of the present invention, the moisture-absorbing ingredient comprises at least one of: rice or salt.

In accordance with some demonstrative embodiments of the present invention, the filling further comprises an insect-repelling ingredient.

In accordance with some demonstrative embodiments of the present invention, the insect-repelling ingredient comprises laurel leaves.

In accordance with some demonstrative embodiments of the present invention, the chambers have a shape selected from the group consisting of: a circle, an oval, a bubble, a rectangle, a square.

In accordance with some demonstrative embodiments of the present invention, each one of the chambers is sealed and is un-openable.

In accordance with some demonstrative embodiments of the present invention, the internal member is formed of cotton.

In accordance with some demonstrative embodiments of the present invention, the external member is formed of fleece.

In accordance with some demonstrative embodiments of the present invention, the external member is formed of velvet.

In accordance with some demonstrative embodiments of the present invention, the external member is formed of corduroy.

In accordance with some demonstrative embodiments of the present invention, the external member is formed of wool.

In accordance with some demonstrative embodiments of the present invention, the external member comprises an external layer and an internal layer; the external layer is formed of a nylon-based material; and the internal layer comprises a heat-retaining material.

In accordance with some demonstrative embodiments of the present invention, the internal member is structured as a dome able to contain therein said bowl.

In accordance with some demonstrative embodiments of the present invention, the internal member is structured as an open box able to contain therein said bowl.

In accordance with some demonstrative embodiments of the present invention, a method of hastening a rise of dough placed inside a bowl, may include: heating an internal member made of fabric, the internal member comprising a plurality of interconnected chambers, wherein the interconnected chambers store solid dry grains that are heatable in a microwave oven; inserting the internal member into an external member made of fabric; wrapping the external member around the bowl.

In accordance with some demonstrative embodiments of the present invention, the heating comprises heating in a microwave oven.

In accordance with some demonstrative embodiments of the present invention, the heating comprises at least a first iteration of heating and a second iteration of heating.

In accordance with some demonstrative embodiments of the present invention, the method may include: folding the internal member in a first way prior to the first iteration of heating, and folding the internal member in a second way between the first and second iterations of heating.

In accordance with some demonstrative embodiments of the present invention, the method may include: turning the internal member upside-down between the first and second iterations of heating.

In accordance with some demonstrative embodiments of the present invention, the wrapping comprises: tying together, around said bowl, two or more strings of the external member.

In accordance with some demonstrative embodiments of the present invention, the method may include: subsequent to heating the internal member and prior to the wrapping, shaking the internal member.

In accordance with some demonstrative embodiments of the present invention, a heating device may include: a pillow-like member comprising a plurality of interconnected compartments having solid reheatable elements therein; a pocket-like member, larger than said pillow-like member, to enclose therein said pillow-like member; and one or more wrapping elements to hold said device around an element to be heated.

In accordance with some demonstrative embodiments of the present invention, the solid reheatable elements comprise one or more types of grains.

In accordance with some demonstrative embodiments of the present invention, the solid reheatable elements comprise one or more ingredients selected from the group consisting of: buckwheat, kasha, flax, linen, rye.

In accordance with some demonstrative embodiments of the present invention, the compartments further comprise: an aromatic agent, a moisture-absorbing material, and an insect repellent.

In accordance with some demonstrative embodiments of the present invention, the one or more wrapping elements comprise one or more strings intended to be tied around said element to be heated.

In accordance with some demonstrative embodiments of the present invention, the solid reheatable elements comprise elements which retain cold temperature upon being chilled.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1A is a schematic illustration of a front-side view of a device wrapped around a bowl while the device is untied, in accordance with the present invention;

FIG. 1B is a schematic illustration of a front-side view of the device wrapped and tied around the bowl, in accordance with the present invention;

FIG. 1C is a schematic illustration of a rear-side view of the device wrapped and tied around the bowl, in accordance with the present invention;

FIG. 2A is a schematic illustration of an internal member of the device, in accordance with the present invention;

FIG. 2B is a schematic illustration of an external member of the device, in accordance with the present invention;

FIG. 2B is a schematic illustration of the external member containing the internal member, in accordance with the present invention;

FIG. 2D is a schematic illustration of the internal member in a folded state, in accordance with the present invention;

FIG. 3 is a schematic illustration of the internal member showing its dimensions, in accordance with a demonstrative embodiment of the present invention

FIG. 4 is a schematic illustration of the external member showing its dimensions, in accordance with a demonstrative embodiment of the present invention;

FIG. 5 is a schematic illustration of an internal member having square-shaped chambers, in accordance with the present invention;

FIG. 6 is a schematic illustration of an internal member having elongated cylindrical chambers, in accordance with the present invention;

FIG. 7 is a schematic illustration of an internal member having bubble-shaped chambers, in accordance with the present invention;

FIG. 8 is a schematic illustration of an internal member having small rectangular chambers, in accordance with the present invention;

FIG. 9 is a schematic illustration of a device shaped as a long chain, wrapped around a bowl in a helix pattern, in accordance with the present invention;

FIG. 10 is a schematic illustration of an internal member shaped as a dome, in accordance with the present invention; and

FIG. 11 is a schematic illustration of an internal member shaped as an open box, in accordance with the present invention.

### DETAILED DESCRIPTION OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

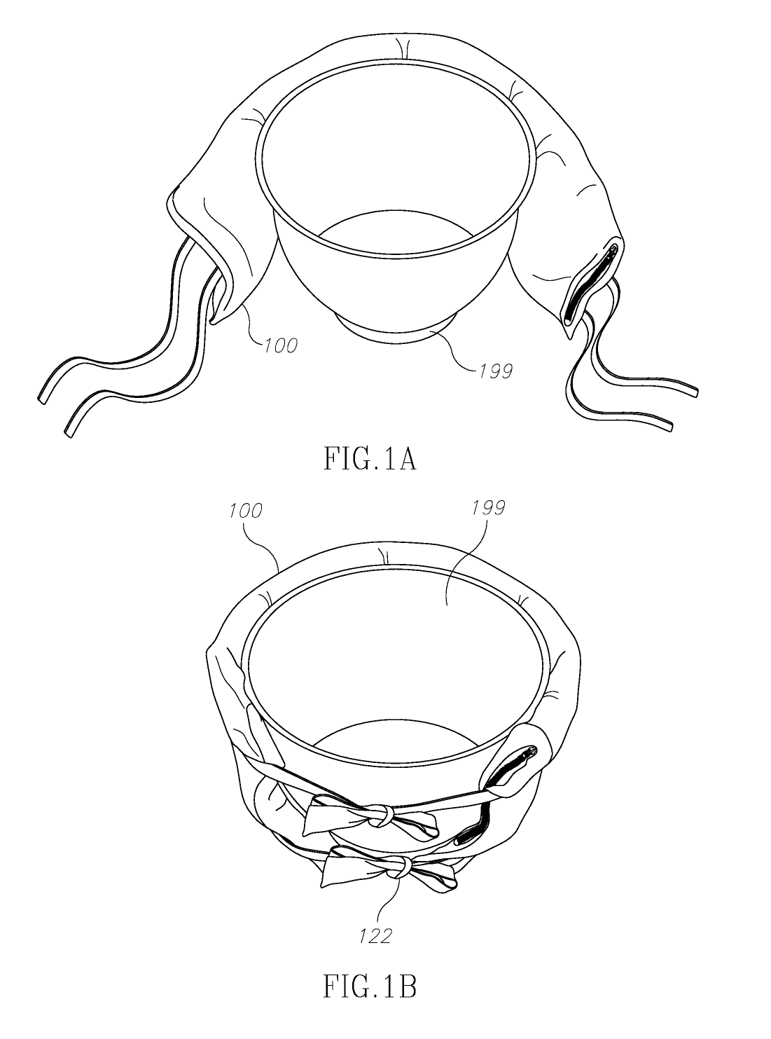

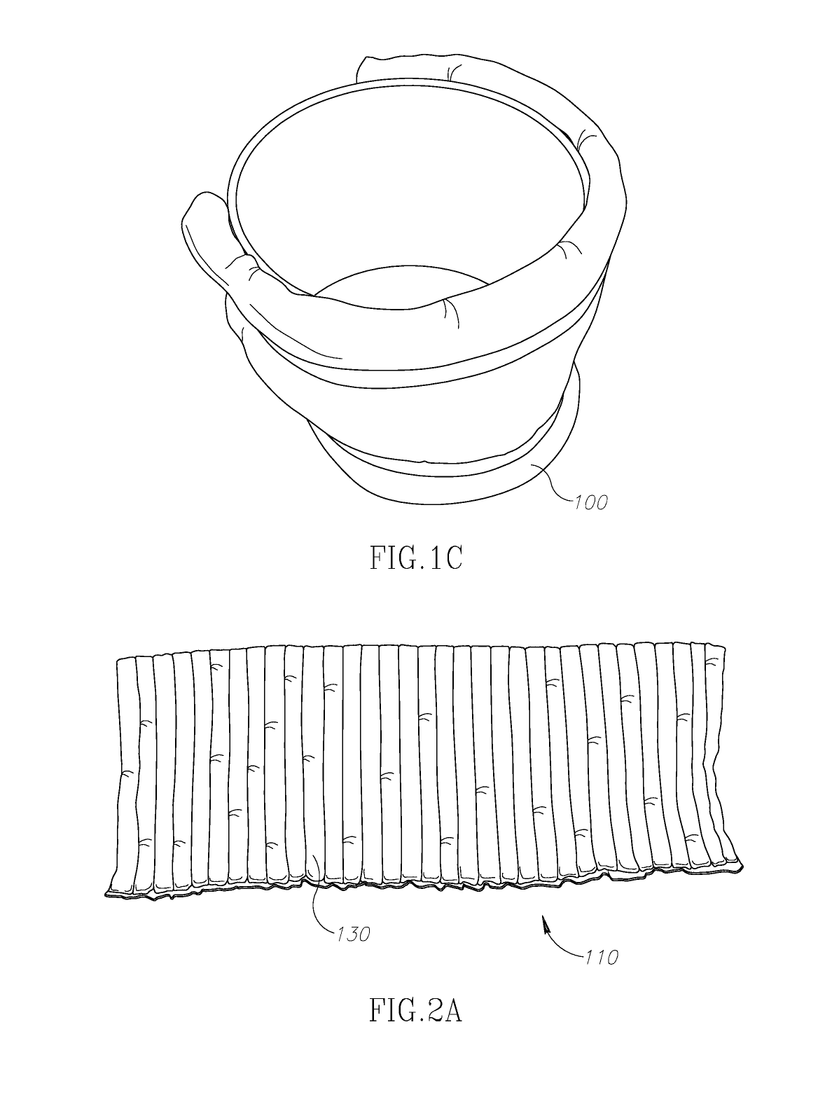

Reference is made to FIGS. 1A-1C, which are schematic illustrations of a baking helper device 100, in accordance with the present invention. Particularly, FIG. 1A shows a front-side view of device 100 partially wrapped around a bowl 199 while device 100 is untied; FIG. 1B shows a front-side view of device 100 fully wrapped and tied around bowl 199; and FIG. 1C shows a rear-side view of device 100 fully wrapped and tied around bowl 199.

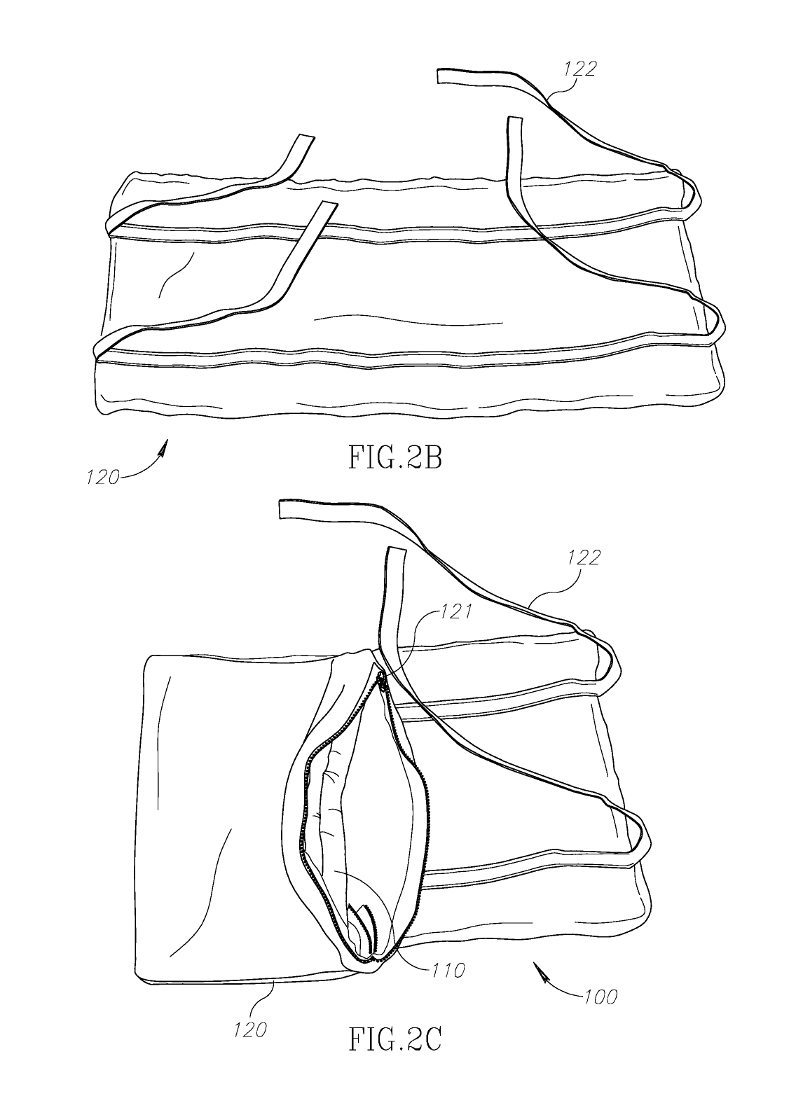

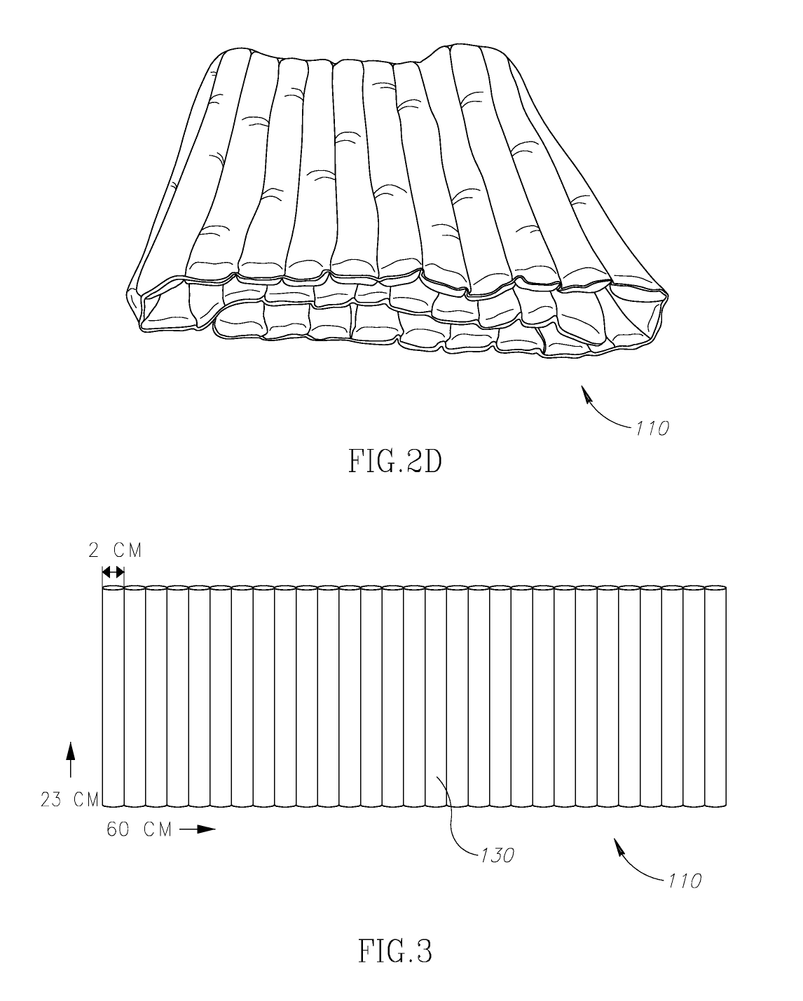

Reference is further made to FIGS. 2A-2C, which are schematic illustrations of components of device 100, in accordance with the present invention. Particularly, FIG. 2A shows an internal member 110 of device 100; FIG. 2B shows an external member 120 of device 100; and FIG. 2C shows external member 120 containing therein internal member 110. Internal member 110 may be referred to herein as “pillow” or “pillow-like member” or “heatable member”; and external member 120 may be referred to herein as “sleeve” or “pocket” or “cover” or “wrapper” or “wrapping pocket” or “non-heatable member”.

Internal member 110 may include a substantially-rectangular or generally-rectangular pillow or pillow-shaped member. Internal member 110 may be of any suitable size or dimensions to wrap a baking element of any kind or of a particular size. For example, for a mixing bowl of a mixer, internal member 110 may measure approximately 60 centimeters in length and approximately 23 centimeters in height. However, this is only a demonstrative example, and other suitable sizes or dimensions may be used.

External member 120 may include a generally-rectangular sleeve or pocket or pouch, able to contain therein internal member 110. External member 120 may be slightly larger (e.g., approximately 5 percent larger) than internal member 110 to allow convenient insertion and removal of internal member 110 vis-a-vis external member 120.

Internal member 110 may be intended for insertion into a microwave oven and/or for heating-up; whereas external member 120 may not be intended for insertion into a microwave oven or for heating-up. Rather, external member 120 may be intended to cover internal member 110 after internal member 120 is heated in a microwave oven (or otherwise) and before internal member 110 is wrapped around bowl 199.

One or more cords 122, strings, or belt-like segments may be affixed to the external side of external member 120 and/or to the external side of the case or sleeve which forms external member 120, in order to allow a user to tie device 100 (e.g., using one or more knots) once device 100 is placed or wrapped around a bowl. The cords or strings may be aesthetically pleasing and also decorative, in addition to their functionality to tie the wrapped device. Cords 122 may protrude, for example, approximately 23 centimeters to the left and approximately 23 centimeters to the right, relative to the rectangular frame of device 100. Other suitable dimensions or sizes may be used. Optionally, a Velcro mechanism (or other fabric hook-and- loop mechanism) or a button mechanism may be used for tying or fastening device 100 around a bowl, or other suitable mechanisms may be used for this purpose.

Optionally, device 100 may have sizes or dimensions suitable to fully wrap around a standard-size bowl or container or mixer-bowl (e.g., home-oriented mixer bowl, industrial-size mixer bowl, or semi-industrial or semi-professional mixer bowl). For example, device 100 may be formed in a size suitable for wrapping around a mixer-bowl having a volume in the range of approximately 4.5 liters to 7 liters. Other suitable bowl volumes may be used.

Optionally, in order to wrap around a larger bowl or mixer-bowl, two or more devices 100 may be used in series, with or without partial overlapping among such devices 100, thereby allowing two or more devices 100 to wrap, entirely or partially, around a larger bowl or mixer-bowl.

Internal member 110 and/or external member 120 may be formed of a suitable cloth or fabric, for example, from cotton or from a mixture of two or more suitable fabrics or materials. Internal member 110 may be formed in a process which may be similar to a process of forming a pillow case, which may be filled with a mixture of grains or cereals as detailed herein. External member 120 may be formed in a process which may be similar to a process of forming a sleeve or a pocket or a pouch.

Internal member 110 may be manufactured as a thin pillow having multiple chambers or compartments 130, for example, approximately 25 or 30 chambers 130. For example, each chamber 130 may be generally rectangular, and the longest dimension of each chamber 130 may be generally perpendicular to the longest dimension of internal member 110. In a demonstrative embodiment of the present invention, each chamber 130 may have, for example, a width of approximately two centimeters, and height of approximately 23 centimeters. Other suitable dimensions or proportions may be used.

Each chamber 130 may be separate and/or discrete from its neighboring chambers 130; or the entirety of internal member 110 may include multiple interconnected chambers 130 (e.g., approximately 25 or 30 interconnected chambers 130). Each chamber 130, or most of chambers 130, may hold grains or cereal. The grains or cereal in one chamber 130 may not be able to mix with grains or cereals in a neighboring chamber 130 or in other chambers 130, and may not be able to shift or to move from one chamber 130 to other chamber(s) 130. This structure may ensure that a particular volume and/or amount of filling (e.g., grains or cereals) are maintained within each chamber 130, and that the filling does not shift un-evenly throughout device 100. Furthermore, this structure may allow device 100 to be more stable, foldable, and/or aesthetic, easier for heating-up and/or holding and/or handling, as well as easier for storing and/or selling.

The depth of internal member 110, or the depth of each chamber 130, may be approximately 2 centimeters in a filled position (namely, filled with the suitable filling of grains or cereals). Other suitable depth values or thickness values may be used.

In some embodiments of the present invention, each chamber 130 may be pre-manufactured or pre-provided to already store a particular amount of filling, which may not be modified or removed by a user of device 100. In other embodiments of the present invention, optionally, each chamber 130 (or some of chambers 130) may have the ability to be opened by a user, who may modify their content by adding filling thereto or by removing filling therefrom.

Each chamber 130 may be, for example, generally rectangular, generally box-shaped, generally cylindrical, generally circular or oval, bubble-shaped, pocket-shaped, egg-shaped, or having other suitable shape.

In some embodiments of the present invention, all chambers 130 may be substantially identical in their size and shape. In other embodiments of the present invention, chambers 130 of device 100 may vary by their size and/or dimensions and/or shape and/or content (e.g., volume of filling and/or weight of filling and/or type of filling). For example, in some embodiments, internal member 110 may optionally include alternating chambers 130, or a pattern of alternating chambers 130, such as, for example, a thick chamber 130 followed by a thin chamber 130 (and so forth), or a large circular chamber 130 followed by a small circular chamber 130 (and so forth), or other suitable chamber patterns.

Optionally, internal member 110 may be formed of 100 percent cotton, thereby allowing heating of internal member 110 in a microwave oven. Optionally, internal member 110 may be formed of corduroy, of velvet, or of other suitable material(s) or fibers, and may optionally have a printing or logo or decorations imprinted thereon or embroidered thereon.

The filling within chambers 130 of device 100 may include, for example, buckwheat, kasha, flax, linen, rye, rice, and/or raw salt. The filling may include other and/or alternate material(s). Optionally, the filling may exclusively include only grains and/or cereals, and may not include liquid materials and/or gel(s). The filling may include only materials which do not change their volume when being heated-up or warmed-up. The filling may exclusively include material(s) which may be microwave-friendly or microwaveable.

Optionally, the filling may include one or more aromatic agents, aroma-therapeutic agents, dry lavender, laurel leaves, daphne leaves, Bay leaves, flower(s), dried flower(s), aromatic extracts, one or more spice(s), aroma-emitting components, or the like. Raw salt may be included in the filling, for example, to attract moisture and/or wetness. Laurel leaves in the filling may keep insects away from device 100, or may eliminate production of insects within or near device 100. Optionally, other suitable components or ingredients may be used for elimination or reduction of insects, to repel insects, or to reduce or collect or absorb moisture.

Optionally, the filling of chambers 130 may include a mixture of buckwheat and rye, which may retain heat and warmth efficiently. For example, buckwheat may have larger grains and may be heavier, and may retain heat well; whereas rye may be efficiently heated up in a microwave oven while having a lighter weight. A mixture of buckwheat and rye grains may have improved results which may feature the ability to be heated up in a microwave oven, the ability to retain heat, and a reasonable weight for handling by a user.

External member 120 may include a case or sleeve or glove or pocket, which may be similar to a pillow case, and may protect internal member 110 from being stained or dirtied. External member 120 may be formed of fleece or other suitable fabric(s) or material(s); and may be replaceable, removable, and/or washable (e.g., by machine gently, or by hand). Optionally, external member 120 may include an opening/closing mechanism, for example, a zipper 121, or buttons, or Velcro, or a “Scotch” mechanism or male-female mechanisms, clickable components, a folding mechanism, or other suitable mechanism(s), at one or more sides or edges of external member 120, in order to allow efficient insertion and removal of internal member 110 to and from external member 120.

Device 100 may be a 100 percent “green” or environmentally-friendly device, formed exclusively of natural materials and/or organic materials and/or recyclable materials and/or bio- degradable materials. Device 100 may be substantially free of metals, of nylon, of synthetic materials, and/or of artificial materials.

Internal member 110 may not be brought in direct contact with water or liquid, and may not be washed or laundered. Optionally, external member 120 may include a fabric-based cover or case or sleeve of device 100 which may be washed or laundered, after being separated from internal member 110. When not in use, device 100 and/or internal member 110 and/or external member 120 may be stored in a cool and dry place, optionally in proximity to laurel leaves.

Optionally, internal member 110 and/or the filling of chambers 130 may include, or may be formed of, synthetic material(s), plastic material(s), polypropylene, or the like. Optionally, internal member 110 and/or the filling of chambers 130 may include one or more gel materials or water or liquid(s), which may be heated up or warmed up by placing internal member 110 within hot water or within boiling water.

Optionally, internal member 110 may include electrical components or wires, and may be similar to an electric blanket which may be warmed up by using an internal electric element which may emit heat once connected to an electric source. Internal member 110 may optionally have an internal battery, a rechargeable battery, and/or may be connectable to an external power source (e.g., provided to internal member 110 via an electric cord).

External member 120 may be formed of, for example, cotton, fleece, corduroy, thick fleece, thin fleece, thermal cloth, wool, angora wool, a heat-retaining material or cloth, down, thin down, light down, thick buckwheat, or the like.

Optionally, external member 120 may be formed of two or more materials. For example, an external side of external member 120 (e.g., the side of external member 120 which is intended to touch bowl 199) may be formed of nylon or nylon-based materials, in order to allow a user to wipe the external side of external member 120 with a wet cloth or a wet towel; whereas, the internal side of external member 120 (e.g., the side of external member 120 which is not intended to be in touch with bowl 199) may be formed of heat-retaining material(s), for example, polypropylene, synthetic material(s), nylon, non-recyclable material(s), or the like.

Reference is made to FIG. 2D, which shows internal member 110 in a folded state or a folded position. The utilization of device 100 may optionally include, for example, folding of internal member 110 in three, for example, by folding one third of internal member 110 into or towards the center of internal member 110, and then folding another third of internal member 110 into or towards the center of internal member 110; or otherwise rolling and/or folding of internal member 110 to achieve a smaller form factor prior to heating up. The folded internal member 110 may then be inserted into a microwave oven, and may be heated up.

Internal member 110 may be heated in a microwave oven or in other suitable way. The heating may include, for example: heating at a maximum level of power for approximately 60 or 75 or 90 or 120 seconds; opening the microwave oven, unfolding or stretching internal member 110 and re-folding it in reverse, then closing the microwave oven; and again, heating at a maximum level of power for approximately 60 or 75 or 90 or 120 seconds.

Alternatively, the heating process of internal member 110 in a microwave oven may include, for example: heating at a maximum level of power for approximately 60 or 75 or 90 or 120 seconds; opening the microwave oven, turning internal member 110 upside-down, closing the microwave oven; and again, heating at a maximum level of power for approximately 60 or 75 or 90 or 120 seconds.

The heating process may allow uniform heating of the entire internal member 110 and avoidance of a result in which several chambers 130 are very hot whereas other chambers 130 are cold or are significantly less hot than several other chambers 130. A conventional microwave oven may be used, without utilizing any “grill” heating feature of such oven. Other suitable durations of heating may be used; and more than two cycles of heating may be used.

In a demonstrative example, upon a first heating iteration in a microwave oven for 90 seconds, the center of internal member 110 may reach a temperature of approximately 45 degrees Celsius; and upon a second heating iteration in a microwave oven for 90 additional seconds, the center of internal member 110 may reach a temperature of approximately 73 to 75 degrees Celsius

Once internal member 110 is heated, it may be removed from the microwave oven, and may be stretched and optionally also slightly shook in order to evenly spread the heated filling within each chamber 130. The heated internal member 110 may then be placed within external member 120, and device 100 may then be wrapped around bowl 199 or other mixer bowl, in a “hugging” formation; optionally, using the one or more cords 122 to tie (e.g., with knots) device 100 around bowl 199.

In a demonstrative experiment, once the heated internal member 110 (measuring approximately 60 by 23 centimeters and having a thickness of approximately 2 centimeters) was inserted into the protective cover of external member 120, the temperature at the center of internal member 110 (measured at the center of external member 120) was approximately 58 degrees Celsius.

Without wrapping device 100 around bowl 199, and after 10 minutes from insertion internal member 110 into external member 120, the temperature at the center of external member 120 may be approximately 58 degrees Celsius.

Without wrapping device 100 around bowl 199, and after 30 minutes from insertion internal member 110 into external member 120, the temperature at the center of external member 120 was approximately 58 or 57 degrees Celsius.

Without wrapping device 100 around bowl 199, and after 40 minutes from insertion internal member 110 into external member 120, the temperature at the center of external member 120 was approximately 54 degrees Celsius.

Without wrapping device 100 around bowl 199, and after 60 minutes from insertion internal member 110 into external member 120, the temperature at the center of external member 120 was approximately 40 degrees Celsius.

In a demonstrative example, internal member 110 was heated up for two iterations of 90 seconds each, in a microwave oven, and was then inserted into external member 120 and then wrapped around bowl 199 containing dough. Temperature measured on the external surface of bowl 199, between bowl 199 and device 100, may be for example: at an initial time point, approximately 27 degrees Celsius; at 6 minutes after the initial time point, approximately 36 degrees Celsius; at 10 minutes after the initial time point, approximately 48 degrees Celsius; at 15 minutes after the initial time point, approximately 47 degrees Celsius; at 25 minutes after the initial time point, approximately 43 degrees Celsius; at 30 minutes after the initial time point, approximately 40 degrees Celsius; at 40 minutes after the initial time point, approximately 37 degrees Celsius; at 50 minutes after the initial time point, approximately 35 degrees Celsius; at 60 minutes after the initial time point, approximately 32 degrees Celsius. Other suitable measurements or values may be achieved.

Bowl 199 may be a metallic or metal-based bowl or mixer-bowl, for example, common in kitchens, manufactured by Kenwood, by KitchenAid, or the like. The metallic structure of bowl 199 may ensure that the heat, which is received from the heated device 100, is retained by bowl 199 and is transferred to the dough (or other food ingredient) within bowl 199. For example, between 1 to 1.5 kilograms of dough may be placed in bowl 199, which may be wrapped with heated device 100. Optionally, bowl 199 may be formed of other materials, non-metallic materials, plastic material(s), heat-retaining material(s), or the like.

Optionally, device 100 may be sized and adapted to fit a mixer-bowl which may have a height greater than its width. This may ensure that device 100 may wrap around the entire outer perimeter of bowl 199. Furthermore, device 100 may be adapted to circle around or wrap around a standard-size mixer-bowl, in order to eliminate a need to transfer the dough from a mixer-bowl (in which the dough is typically prepared) into another bowl for having the dough rise.

Optionally, bowl 199 may be covered with a cover, a nylon, a nylon wrap, a Saran wrap, a freshness-sealing wrap, or the like. Optionally or alternatively, the entire bowl 199, having device 100 wrapped around it, may be uncovered and may be placed entirely within a nylon bag or a plastic bag, while leaving room for the dough to rise and to optionally reach beyond or above bowl 199. Alternatively, device 100 may be wrapped around bowl 199 which may already be wrapped within a plastic bag or a nylon bag.

Device 100 may be re-used, optionally with re-heating cycles, for expediting or hastening the rise of multiple portions of dough, or for multiple consecutive iterations (e.g., in a cooking or baking process or recipe which requires multiple iterations of rising of dough).

The heat that device 100 may emit may be such that it does not harm the yeast which may exist within the dough. Rather, the yeast may utilize the heat in order to further expedite their rising or the rising of the dough. Furthermore, the indirect heat, which arrives to the dough from bowl 199 rather than from internal member 110 itself, may further be such heat which may not destroy the yeast within the dough.

Optionally, if the amount of dough is large, or if the dough is heavy and/or oily or requires a longer period of rising (e.g., in cold weather or in a cold kitchen), then device 100 may be re-used multiple times, optionally with re-heating of internal member 110 in the microwave oven between such iterations.

Optionally, device 100 may further be utilized for additional purposes, in addition to or instead of being wrapped around bowl 199 of rising dough. For example, once the dough has risen, the dough may be taken out of bowl 199 onto a working area, and may be processed in order to prepare a desired food item. However, in some food items, a yeast-based dough may benefit from, or may require, an additional iteration of rising after the food item is formed but before the food item is baked in an oven. Accordingly, the formed but not-yet-baked food item may be placed in a baking tray (for example, on top of baking paper or parchment paper); internal member 110 or device 100 may be heated in a microwave oven, and may be inserted into external member 120; and the baking tray may be placed on top of the stretched-open device 100 in order to support or expedite the additional rising of the dough within the pre-baked food item. The baking tray may, meanwhile, be covered with a nylon or Saran wrap, in order to avoid drying up of an upper layer of the food item.

Device 100 may optionally be used for other purposes, for example: as a heat-retaining article which may be placed in a food basket or a lunch-box or a picnic-box or other heat-retaining box or container. Optionally, device 100 or internal member 110 may be cooled-up (e.g., in a freezer) in order to retain a cold temperature which may be transferred to food items in such containers.

Device 100 may provide an environmentally-friendly solution, to a home user or a cook or a chef or a baker, or to a user that would like to bake dough-based food items while hastening or expediting the length of time required for the dough to rise.

Device 100 may be useful for home users who would like to rapidly prepare or bake dough-based food items, but are hesitant to do so due to the need to wait a long time for the dough to rise, or due to time constraints (e.g., a Jewish baker who needs to bake Challah bread before the beginning of the Shabbat day). Device 100 may significantly shorten the time necessary for the rising of dough.

Internal member 110 and/or external member 120 may be decorated or colored with decorations, imprints, embroidery, a company logo, or other suitable components, and may be re-usable numerous times or virtually unlimited number of times.

Device 100 may be marketed together with baking recipes, a manual of instructions, and detailed instructions of operation utilizing text and/or graphics.

Optionally, device 100 may be sold as part of a kit, which may include: a mixer, a mixer-bowl, an implementation of internal member 110 formed in a size suitable to wrap around the particular mixer bowl, and a matching external member 120.

Device 100 may be suitable for heating in a microwave oven; but may not be suitable for heating in a conventional oven, which may cause device 100 to burn.

Optionally, device 100 and/or internal member 110 may be placed in a freezer or a refrigerator or a deep-freezer or a cooler or a cooling device, in order to cool-down or chill-down device 100 and/or internal member 110, which may then be used as cold-retaining components. In some embodiments of the present invention, chambers 130 may include a single type of filling or grains, which may be able to both retain heat (upon being heated) and retain chill (upon being cooled-down). In other embodiments of the present invention, chambers 130 may include two or more types of fillings or grains, for example, a first type which may retain heat (upon being heated), and a second type which may retain chill (upon being cooled-down).

Optionally, instead of wrapping device 100 around bowl 199, device 100 may be placed on top of bowl 199 and/or under bowl 199, thereby providing indirect heat from these directions to the dough or other ingredients within bowl 199.

Optionally, a baking method which utilizes device 100 may include: heating-up internal member 110, and utilizing device 100 to perform a first iteration of rising of the dough in bowl 199; designing or shaping of the dough as pre-baked items placed within a baking tray or other container; re-heating internal member 110 and placing device 100 under the baking tray, for a second iteration of heating and dough-rising, optionally while the pre-baked items are also covered with a nylon sheet or Saran wrap (thereby hastening the second iteration of dough-rising).

Reference is made to FIG. 3, which is a schematic illustration of internal member 110 showing its dimensions in accordance with a demonstrative embodiment of the invention. Other suitable dimensions or proportions may be used.

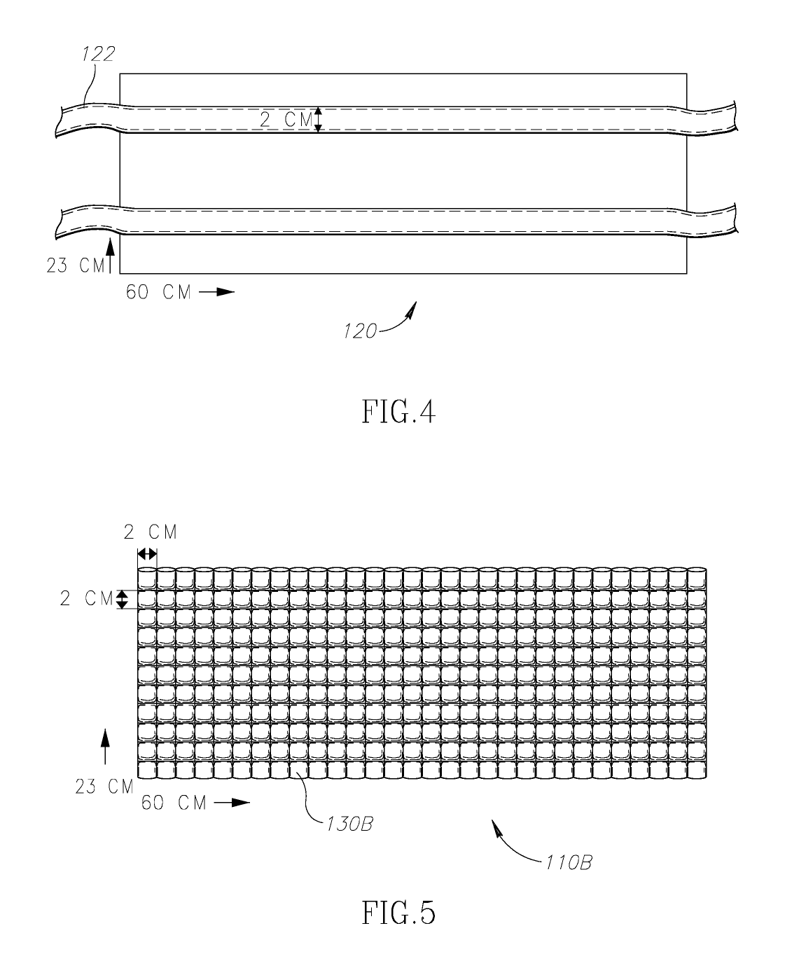

Reference is made to FIG. 4, which is a schematic illustration of external member 120 showing its dimensions in accordance with a demonstrative embodiment of the invention. Other suitable dimensions or proportions may be used.

Reference is made to FIG. 5, which is a schematic illustration of an internal member 110B having square-shaped chambers 130B, in accordance with a demonstrative embodiment of the invention. Other suitable shapes may be used.

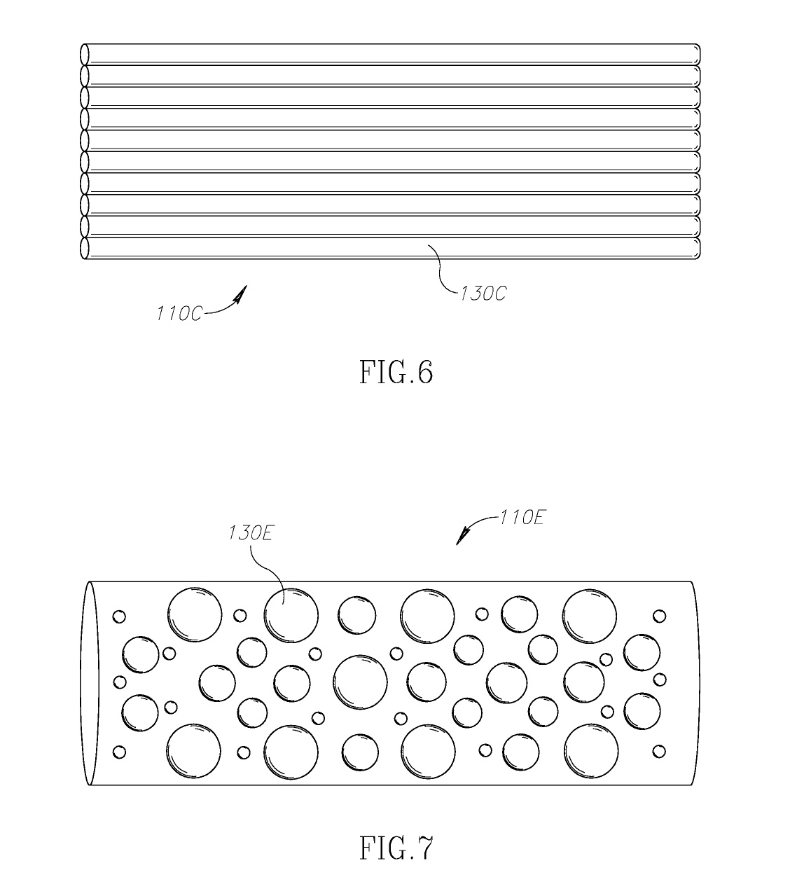

Reference is made to FIG. 6, which is a schematic illustration of an internal member 110C having elongated shaped chambers 130C which may be tubular or cylindrical, in accordance with a demonstrative embodiment of the invention. Other suitable shapes may be used.

Reference is made to FIG. 7, which is a schematic illustration of an internal member 110E having bubble-shaped chambers 130E, in accordance with a demonstrative embodiment of the invention. Other suitable shapes may be used.

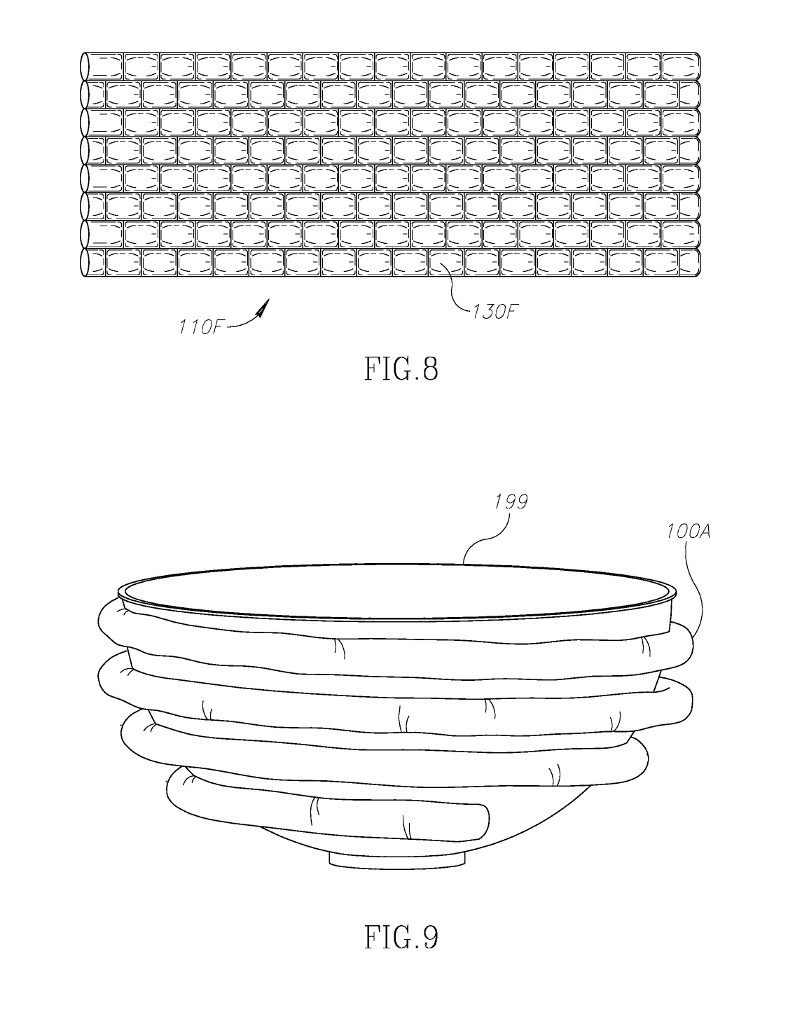

Reference is made to FIG. 8, which is a schematic illustration of an internal member 110F having small rectangular chambers 130F, in accordance with a demonstrative embodiment of the invention. Other suitable shapes may be used.

Reference is made to FIG. 9, which is a schematic illustration of a device 100A shaped as a long chain or “snake” or string, which may be wrapped around bowl 199 in a helix pattern or a spiral pattern or a spring pattern. Device 100A may include an internal member contained within an external member. Alternatively, device 100A may include only a single member (an internal member) which may be directly wrapped around bowl 199 without utilizing an external member or sleeve.

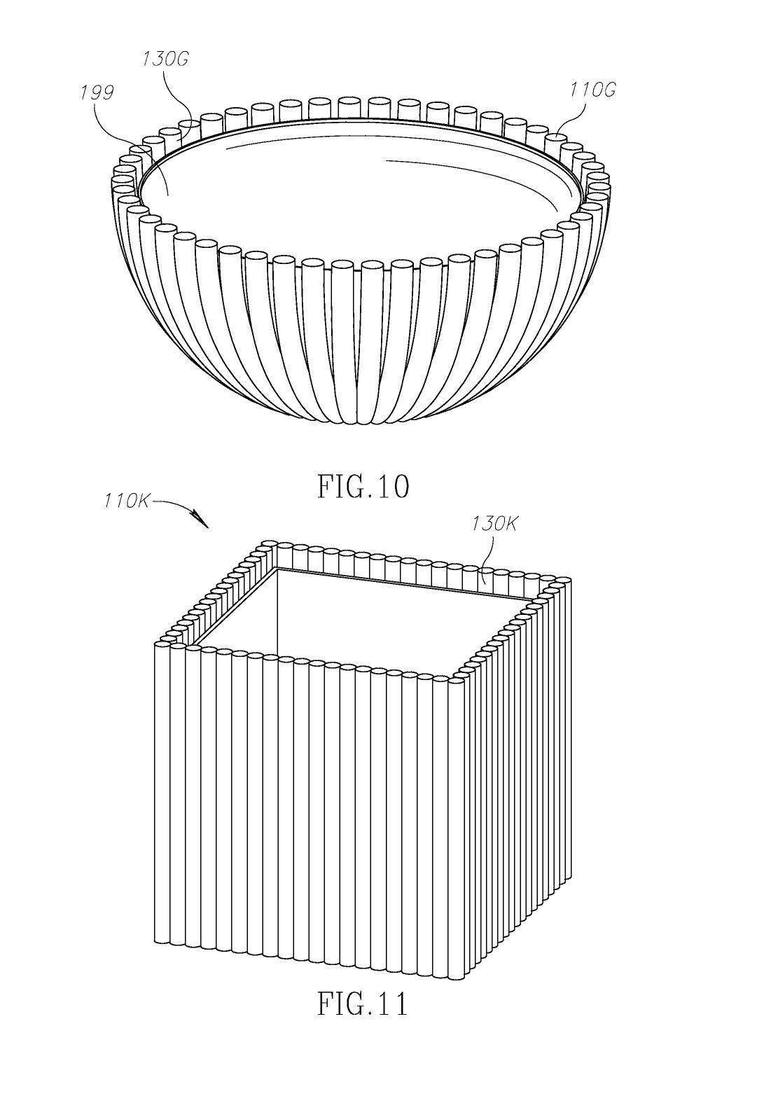

Reference is further made to FIG. 10, which is a schematic illustration of an internal member 110G shaped as a dome, or as half of a sphere, such that bowl 199 may be placed within such structure or semi-spherical pocket. Internal member 110G is shown directly wrapping around bowl 199; optionally, internal member 110G may be contained within a suitable external member.

Reference is further made to FIG. 11, which is a schematic illustration of an internal member 110K shaped as an open box or a standing pocket, such that bowl 199 may be placed within such structure. Internal member 110G is shown directly wrapping around bowl 199; optionally, internal member 110K may be contained within a suitable external member.

The term “dough” as used herein may include, for example, a paste or a mix made out of any one or more cereals and/or grains and/or leguminous crops, for example, by mixing flour of any suitable type with a small amount of water and/or other liquid(s), and optionally with other suitable ingredients (e.g., salt, sugar, eggs). The dough may be a precursor to preparing various food items, breads, and/or bread-based items, for example, bread loaf, cake, roll, baguette, flatbread, noodles, crusts, pastry, baked goods, fried goods, oven-baked goods, or the like. The dough may include, for example, wheat, maize, corn, rice, sorghum, and/or other cereals or related crops. The dough may or may not include yeast, or one or more types of fermented material(s) or fungi or bacteria or organism, which may support and/or facilitate the rise of such dough. The term “dough” may optionally include other suitable materials or ingredients, for example, sourdough, starter, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. A device for hastening a rise of dough placed inside a bowl, the device comprising:
an internal member made of fabric, the internal member comprising a plurality of interconnected chambers having therein solid dry grains that are heatable in a microwave oven; and
an external member to enclose therein said internal member after said internal member is heated in the microwave oven,
wherein the device is wrapable around said bowl.

2. The device of claim 1, wherein the external member comprises two or more cords to tie together two opposite sides of the device when the device is wrapped around said bowl.

3. The device of claim 2, wherein the external member comprises a fabric pocket, wherein a first side of the pocket is closed, and wherein a second, opposite, side of the pocket is open; wherein the second side of the pocket comprises a closing and opening mechanism.

4. The device of claim 3, wherein the closing and opening mechanism comprises a mechanism selected from the croup consisting of: a zipper, and a fabric hook-and-loop fastener.

5. The device of claim 1, wherein the internal member is generally rectangular, wherein the external member is generally rectangular, and wherein each chamber is generally rectangular; wherein a long dimension of the internal member is generally perpendicular to a long dimension of said chambers.

6. The device of claim 1, wherein the solid dry grains comprise one or more grains selected from the group consisting of: buckwheat, kasha, flax, linen, rye.

7. The device of claim 1, wherein the filling further comprises an aromatic agent; wherein the aromatic agent comprises one or more materials selected from the group consisting of: dry lavender, laurel leaves, daphne leaves, Bay leaves, flowers, dried flowers, aromatic extracts, one or more spices, aroma-emitting components, and aroma-therapeutic agents.

8. The device of claim 1, wherein the filling further comprises a moisture-absorbing ingredient; wherein the moisture-absorbing ingredient comprises at least one of: rice or salt.

9. The device of claim 1, wherein the filling further comprises an insect-repelling ingredient; wherein the insect-repelling ingredient comprises laurel leaves.

10. The device of claim 1, wherein the chambers have a shape selected from the group consisting of: a circle, an oval, a bubble, a rectangle, a square;
wherein each one of the chambers is sealed and is un-openable.

11. The device of claim 1, wherein the internal member is formed of cotton;
wherein the external member is formed of a material selected from the group consisting of: fleece, velvet, corduroy, and wool.

12. The device of claim 1, wherein the external member comprises an external layer and an internal layer; wherein the external layer is formed of a nylon-based material; wherein the internal layer comprises a heat-retaining material.

13. The device of claim 1, wherein the internal member is structured as a structure selected from the group consisting of:
a dome able to contain therein said bowl; and
an open box able to contain therein said bowl.

14. The device of claim 1, wherein the interconnected chambers comprise elements which retain cold temperature upon being chilled.

15. A heating device comprising:
a pillow-like member comprising a plurality of interconnected compartments having solid reheatable elements therein;
a pocket-like member, larger than said pillow-like member, to enclose therein said pillow-like member; and
one or more wrapping elements to hold said device around an element to be heated.

16. The device of claim 15, wherein the solid reheatable elements comprise one or more types of grains.

17. The device of claim 15, wherein the solid reheatable elements comprise one or more ingredients selected from the group consisting of: buckwheat, kasha, flax, linen, rye.

18. The device of claim 15, wherein the compartments further comprise:
an aromatic agent, a moisture-absorbing material, and an insect repellent.

19. The device of claim 15, wherein the one or more wrapping elements comprise one or more strings intended to be tied around said element to be heated.

20. The device of claim 15, wherein the solid reheatable elements comprise elements which retain cold temperature upon being chilled.
